(19) United States
(12) Patent Application Publication
(10) Pub. No.: US 2007/0128370 A1
(43) Pub. Date: Jun. 7, 2007

(54) Coating material, method for manufacturing optical film using the coating material, optical film, polarizing plate and image display apparatus

(75) Inventors: Katsunori Takada, Osaka (JP); Takashi Yamaoka, Osaka (JP); Taku Yamada, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 10/588,308

(22) PCT Filed: Feb. 2, 2005
(86) PCT No.: PCT/JP05/01510

§ 371 Date: Aug. 3, 2006

(30) Foreign Application Priority Data
Feb. 6, 2004 (JP) 2004-030891

(51) Int. Cl. B05D 3/02; B32B 9/06

(52) U.S. Cl. 427/387; 428/212; 428/452

(57) ABSTRACT

The present invention provides a coating material for forming a coating layer that can achieve excellent adhesion to a transparent film. The coating material is prepared so that it contains a thermosetting resin, an inorganic filler, and a mixed solvent containing cyclohexanone. The content of the thermosetting resin is in the range from 5 to 20 wt % with respect to the total amount of the thermosetting resin and the inorganic filler, and the content of the cyclohexanone is in the range from 25 to 35 wt % with respect to the entire mixed solvent. By coating a surface of a transparent film with this coating material and then heat-treating the resultant coating, a coating layer with excellent adhesion can be formed on transparent film. The thus-obtained laminate of the transparent film and the coating layer can be used as an antireflection film.

### TECHNICAL FIELD

The present invention relates to a coating material, a method for manufacturing an optical film using the coating material, an optical film, a polarizing plate, and an image display apparatus.

### BACKGROUND ART

Optical products such as various image display apparatuses typified by liquid crystal displays, organic electroluminescence (EL) displays, and plasma displays (PD) and sunglasses and goggles employ various optical films in accordance with the intended use. Among these optical products, in image display apparatuses, especially monitors for car navigation systems and video cameras that are frequently used under bright lighting or outdoors, a decrease in visibility due to the reflection on the monitor surface is significant. Thus, an antireflection treatment usually is performed with respect to the monitor surface by arranging an antireflection film that scatters or disperses light thereon.

In general, the antireflection film can be formed by laminating a plurality of thin films that are formed of materials with different refractive indices according to a dry method such as vacuum deposition, sputtering, or CVD or a wet method such as die coating or gravure roll coating. With such a configuration, it is possible to minimize the reflection in the visible light region, for example. Also, an antireflection film obtained by first laminating a layer exhibiting a relatively high refractive index on a surface of a transparent film base and then further laminating a layer exhibiting a relatively low refractive index thereon has been reported. This antireflection film prevents reflection by canceling out reflected light through the effect of interference of light (see Patent Document 1, for example).

In general, films formed of triacetyl cellulose (TAC), polycarbonate, acrylic resins, and the like commonly have been used as the above-described transparent film base because they are reasonably inexpensive and have excellent optical characteristics and reliability under various environments. However, the antireflection film has a problem concerning the adhesion between such a transparent film and a layer exhibiting the above-described antireflection function (an antireflection layer). This is because resins used for forming the antireflection layer, such as siloxane-based resins, acrylic resins, epoxy-based resins, and the like originally achieve poor adhesion to the resins used for forming the transparent film base. Moreover, among various transparent film bases, especially the one formed of TAC has a high hygroscopicity and a high thermal expansion coefficient and thus has a drawback in that the size thereof is liable to change due to the change in temperature or humidity. This gives rise to a problem concerning the durability of the antireflection film, because a great stress is applied to the antireflection layer laminated thereon so that the antireflection layer might peel off from the transparent film base, for example. This problem is significant especially in displays for car navigation systems that quickly have gained popularity in recent years, because the temperature and humidity change very widely in cars.

As a method for solving such a problem, a method has been reported that forms an antireflection layer by dissolving an ultraviolet (UV)-curing resin as a material of the antireflection layer in MIBK (methyl isobutyl ketone) as a solvent to prepare a coating material, coating a transparent film with this coating material, and then performing an ultraviolet treatment with respect to the resultant coating so as to harden the resin (see Patent Document 2, for example). However, since this method employs a UV-curing resin, there has been a problem in that an attempt to form a thin coating may cause sufficient hardening of the UV-curing resin to be hindered by oxygen, so that the resultant coating cannot have a sufficient hardness. Thus, according to this method, it is difficult to set the thickness of the antireflection layer to be 0.5 μm or smaller.
Patent Document 1: JP 2002-301783 A
Patent Document 2: JP 11(1999)-209717 A

### DISCLOSURE OF INVENTION

### Problem to be Solved by the Invention

With the foregoing in mind, it is an object of the present invention to provide a coating material capable of forming a coating layer that also serves as an antireflection layer and achieves excellent adhesion to a transparent film even when the thickness of the coating layer is small.

### MEANS FOR SOLVING PROBLEM

In order to achieve the above object, the present invention provides a coating material for forming a coating layer on a surface of a transparent film. The coating material contains: a thermosetting resin; an inorganic filler; and a mixed solvent that contains at least two solvents. In this coating material, the content of the thermosetting resin is in the range from 5 to 20 wt % with respect to the total amount of the thermosetting resin and the inorganic filler, and the mixed solvent contains cyclohexanone so that the content of the cyclohexanone is in the range from 25 to 35 wt % with respect to the entire mixed solvent.

### EFFECTS OF THE INVENTION

With the above-described configuration, the coating material of the present invention can form a coating layer that also serves as an antireflection layer and achieves excellent adhesion to a transparent film even when the thickness of the coating layer is small. More specifically, since the coating material of the present invention contains the inorganic filler, the coating layer formed using this coating material also serves as an antireflection layer. Furthermore, since the coating material of the present invention contains a thermosetting resin as a curable resin, it is not subjected to an influence of oxygen or the like even when forming a thin coating, and thus it is possible to obtain a thin coating with sufficient strength and hardness. Still further, since the coating material of the present invention contains the mixed solvent containing cyclohexanone, it is possible to achieve sufficient adhesion to the transparent protective film even when the thickness of the coating layer is small. The reason for this is not known, but the speculation by the inventors of the present invention is as follows. That is, in the case where the content of cyclohexanone in the mixed solvent is in the above-described range, the surface of the transparent film is dissolved partially by the mixed solvent when the coating material of the present invention is applied thereto. The dissolved region has been corroded with the coating material. In the region corroded with the coating material (the dissolve region), the mixture of the dissolved transparent film and the coating material is hardened, whereby a so-called anchor effect is produced to improve the adhesion between the transparent film and the coating layer. Such an effect can be obtained when the content of cyclohexanone is in the above-described range. The relationship between the content of cyclohexanone in the mixed solvent and the effect of improving adhesion was first discovered by the inventors of the present invention. It should be noted that the present invention is by no means limited by the above-described speculation.

As described above, by coating the transparent film with the coating material of the present invention and then hardening the resultant coating to obtain a coating layer, it is possible to obtain an optical film of the present invention that achieves excellent adhesion between the transparent film and the coating layer. Moreover, since the present invention employs a thermosetting resin as described above, the above-described problem occurring when an ultraviolet-curing resin is employed can be avoided, so that, even when the thickness of the coating layer is small (e.g. 0.5 μm or smaller), the resin can be hardened sufficiently and the coating layer can have a sufficient hardness. Also, since the coating material of the present invention contains the inorganic filler as described above, the coating layer obtained also can exhibit an antireflection function. An optical film formed using the coating material of the present invention has a sufficient hardness and achieves excellent adhesion between the transparent film and the coating layer. Thus, for example, the transparent film and the coating layer do not separate from each other under the conditions where the temperature or humidity changes widely, so that the optical film can exhibit excellent reflection characteristics. Accordingly, the optical film is useful in various image display apparatuses such as displays for car navigation systems as described above.

### DESCRIPTION OF THE INVENTION

As described above, a coating material of the present invention contains a thermosetting resin, an inorganic filler, and a mixed solvent containing cyclohexanone, and the content of the thermosetting resin is in the range from 5 to 20 wt % with respect to the total amount of the thermosetting resin and the inorganic filler while the content of the cyclohexanone is in the range from 25 to 35 wt % with respect to the entire mixed solvent.

The content of cyclohexanone in the mixed solvent can be determined arbitrarily as long as it is in the range from 25 to 35 wt %, preferably from 30 to 35 wt %, and particularly preferably from 32 to 34 wt %. When the content of cyclohexanone is less than 25 wt %, the transparent film such as a TAC film is not dissolved sufficiently, which may lead to insufficient adhesion between the transparent film and the coating layer, for example. On the other hand, when the content of cyclohexanone is more than 35 wt %, the transparent film is dissolved too much, so that whitening might occur in the resultant optical film and elution of the resin forming the transparent film might occur to degrade the adhesion strength between the transparent film and the coating layer, for example.

Moreover, cyclohexanone has a relatively high boiling point of 155.7° C. so that, for example, there is no fear that cyclohexanone might be evaporated before the transparent film has been dissolved partially. Thus, for example, by setting the condition for drying the coating as appropriate, it is possible to adjust the corrosion of the transparent film by the coating material.

The composition of the mixed solvent is not particularly limited as long as it contains cyclohexanone so that the content thereof is in the above-described range. The solvent other than cyclohexanone to be contained in the mixed solvent can be selected from various solvents including alcohol-based solvents such as ethanol, methanol, isobutyl alcohol, and diacetone alcohol, methyl ethyl ketone (MEK), propylene glycol monomethyl ether (PGM), n-butyl acetate, ethylcellosolve, methyl isobutyl ketone (MIBK), and cyclopentanone, for example. These solvents may be contained in the mixed solvent together with cyclohexanone either alone or in combination of at least two kinds thereof.

The thermosetting resin is not particularly limited, and any conventionally known thermosetting resin can be used. It is to be noted here that the thermosetting resin refers to a resin that turns into an insoluble and infusible resin when its molecular weight is increased and a network-like three-dimensional structure is formed through a chemical reaction caused by heat (such as a hardening reaction or a crosslinking reaction), and in the coating material according to the present invention, the thermosetting resin means a material (e.g., a monomer or a prepolymer) forming the coating material, i.e., an unhardened thermosetting resin. It is preferable that the thermosetting resin contains an inorganic thermosetting resin, which preferably is a siloxane-based resin, for example. As the inorganic resin (a material forming the resin), it is preferable to use, for example, alkoxysilane that forms a polysiloxane structure when hardened by heat or a partial condensation product or condensation product thereof. Specific examples of the alkoxysilane include: tetraalkoxysilanes such as tetramethoxysilane, tetraethoxysilane, tetrapropoxysilane, tetraisopropoxysilane, and tetrabutoxysilane; trialkoxysilanes such as methyltrimethoxysilane, methyltriethoxysilane, methyltripropoxysilane, methyltributoxysilane, ethyltrimethoxysilane, ethyltriethoxysilane, n-propyltrimethoxysilane, n-propyltriethoxysilane, isopropyltrimethoxysilane, isopropyltriethoxysilane, vinyltrimethoxysilane, vinyltriethoxysilane, 3-glycidoxy-propyltrimethoxysilane, 3-glycidoxy-propyltriethoxysilane, 3-mercaptopropyltrimethoxysilane, 3-mercaptopropyltriethoxysilane, phenyltrimethoxysilane, phenyltriethoxysilane, and 3,4-epoxycyclohexylethyltrimethoxysilane; dimethyldimethoxysilane, dimethyldiethoxysilane, diethyldimethoxysilane, and diethyldiethoxysilane; and partial condensation products and condensation products thereof. Among these, tetraalkoxysilanes and partial condensation products thereof are preferable, and tetramethoxysilane, tetraethoxysilane, and partial condensation products thereof are particularly preferable. These thermosetting resins may be used alone or in combination of at least two kinds thereof.

The content of the thermosetting resin in the coating material of the present invention is in the range from 5 to 20 wt % with respect to the total amount of the thermosetting resin and the inorganic filler as described above, preferably from 10 to 15 wt %. When the content of the thermosetting resin is less than 5 wt %, there arises a problem in that adhesion between adjacent layers tends to be degraded, for example. On the other hand, when the content of the thermosetting resin is more than 20 wt %, no problem occurs concerning the adhesion. However, in order to impart an antistatic function to the coating layer, it is preferable that the content of the thermosetting resin is 20 wt % or smaller.

The inorganic filler is not particularly limited, but it is preferable to use fine particles of an inorganic material as the inorganic filler. The inorganic material can be a conductive material, for example, and fine particles of a conductive metal or metal oxide can be used as the inorganic filler. Specific examples of the metal include antimony, selenium, titanium, tungsten, tin, zinc, indium, and zirconia. Specific examples of the metal oxide include those exhibiting a high refractive index, such as antimony oxides, selenium oxides, titanium oxides, tungsten oxides, tin oxides, antimony-doped tin oxides (ATOs (tin oxides doped with antimony)), phosphorus-doped tin oxides, zinc oxides, zinc antimonate, and tin-doped indium oxides. Among these, antimony-doped tin oxides, phosphorus-doped tin oxides, zinc antimonate, tin-doped indium oxides etc. are preferable, and antimony-doped tin oxides are particularly preferable.

The inorganic filler preferably is composed of fine particles with an average particle diameter of 0.1 μm or smaller, more preferably 80 nm or smaller, still more preferably 60 nm or smaller, and particularly preferably 10 to 30 nm. When the average particle diameter is 0.1 μm or smaller, it is possible to reduce the haze value of the resultant coating layer, thus obtaining a sufficient transparency. It is to be noted here that the inorganic filler to be used may be composed of fine particles with a uniform size or may be a mixture of fine particles with different sizes. Since the coating material of the invention contains such a filler, the surface of the resultant coating layer is roughened so that the coating layer can exhibit an antireflection function.

The average particle diameter of the inorganic filler is not particularly limited, and can be measured using a laser diffraction/scattering particle size distribution analyzer (trade name: LA-920; manufactured by JASCO Corporation), for example.

The form of the inorganic filler when preparing the coating material of the present invention is not particularly limited. The inorganic filler may be in the form of powder, but preferably is in the form of sol because it can provide excellent dispersibility. Such a sol form with high dispersibility can be achieved by, for example, dispersing the inorganic filler in a dispersion medium such as water, alcohol, ester, or hydrocarbon. When the inorganic filler is in the form of sol as described above, it is preferable that the inorganic filler contains as a main component a metal oxide such as an antimony-doped tin oxide, a phosphorus-doped tin oxide, zinc antimonate, or a tin-doped indium oxide. Among these, an antimony-doped tin oxide is particularly preferable because it is excellent in stability in the coating material and in sol reproducibility.

The total content of the thermosetting resin and the inorganic filler in the coating material of the present invention preferably is, for example, 0.5 to 5 wt %, more preferably 1 to 2 wt % with respect to the total amount of the thermosetting resin, the inorganic filler, and the mixed solvent.

The coating material of the present invention may further contain various additives as necessary, in addition to the thermosetting resin, the inorganic filler, and the mixed solvent. Examples of the additive include a stabilizer.

The coating material of the present invention can be prepared by mixing at least the above-described thermosetting resin, inorganic filler, and mixed solvent. The order of mixing these components is not particularly limited, but can be such that the thermosetting resin and the inorganic filler are dispersed in the mixed solvent, for example. The coating material of the present invention as described above is useful for coating various transparent films that will be described later, but particularly is useful for coating a TAC film, especially an unsaponified TAC film, because of the quality of the film. This is because, although the saponification of a film generally is carried out, for example, to improve the wettability of the film so as to improve adhesion to other films, it is possible to impart excellent adhesion to unsaponified films, especially to an unsaponified TAC film, by using the coating material of the present invention. Moreover, with regard to the use of the coating material of the present invention, the coating material also is useful for coating a transparent film that serves as a protective film of a polarizing plate.

Next, a method for manufacturing an optical film according to the present invention is a method for manufacturing an optical film that includes a transparent film and a coating layer formed on a surface of the transparent film. The method includes: coating the surface of the transparent film with the coating material according to the present invention to form a coating; and heat-treating the coating to obtain the coating layer.

One example of a method for manufacturing an optical film according to the present invention will be described. It is to be noted, however, that the method for manufacturing an optical film according to the present invention is by no means limited to the following example.

First, as described above, the coating material of the present invention is applied to a surface of the transparent film to form a coating. It is to be noted here that one or both surfaces of the transparent film may be coated with the coating material.

After the surface of the transparent film has been coated with the coating material, the coating may be subjected to a drying treatment prior to a hardening treatment (a heat treatment) that will be described later. This drying treatment usually can be carried out by natural drying, or alternatively, a heat treatment for a drying purpose that is different from a heat treatment that will be described later may be carried out. In the latter case, the treatment time is, for example, about 30 seconds or less, and the treatment temperature is, for example, room temperature or a temperature in the range from about 30° C. to 90° C.

Examples of the transparent film include a TAC film, a polycarbonate film, and an acrylic film. However, the coating material of the present invention is useful for coating a TAC film, especially a TAC film that is not saponified. The size of the transparent film can be determined as appropriate depending on its use, but the thickness of the transparent film usually is 10 to 100 μm, preferably 40 to 80 μm.

The method of coating the surface of the transparent film with the coating material is not particularly limited, and can be, for example, spin coating, roller coating, flow coating, printing, dip coating, film flow-expanding, bar coating, gravure printing, a doctor blade method, gravure roller coating, die coating, or the like. The amount of the coating material used for coating the surface of the transparent film can be determined as appropriate depending on, for example, a desired thickness of the coating layer obtained finally etc.

Usually, the thickness of the coating can be determined as appropriate depending on, for example, a desired thickness of the coating layer obtained finally etc. However, when the coating is subjected to a drying treatment, the thickness of the coating after the drying treatment preferably is in the range from 50 to 500 nm, more preferably from 70 to 100 nm. When the thickness of the coating is 50 nm or larger, the coating can exhibit a sufficient conductivity in the case where a conductive material is used as the inorganic filler, for example. On the other hand, when the thickness of the coating is 500 nm or smaller, the time required for drying may be short and besides, excessive dissolving of the transparent film by the mixed solvent contained in the coating material can be prevented sufficiently so that whitening does not occur in the resultant optical film.

Next, the coating formed on the transparent film is subjected to a heat treatment. By this heat treatment, the thermosetting resin contained in the coating is hardened, thus providing a coating layer on the transparent film.

The condition for the heat treatment can be determined as appropriate depending on, for example, the type of the thermosetting resin, the thickness of the coating, etc. However, the heat treatment usually can be carried out at 50° C. to 200° C. for 0.5 to 10 minutes, preferably at 100° C. to 160° C. for 1 to 5 minutes, and more preferably at 110° C. to 140° C. for 2 to 3 minutes.

In the above-described manner, the optical film including the transparent film and the coating layer formed on the transparent film can be obtained. The thus-obtained optical film of the present invention is excellent in adhesion between the transparent film and the coating layer. Accordingly, the above-described problem of the separation of the transparent film and the coating layer does not occur in the optical film of the present invention, and thus the optical film can be used suitably in an environment where the temperature and humidity are liable to change, for example, and can exhibit a sufficient reliability when used as an optical film for vehicle-mounted image display apparatuses etc. Moreover, the optical film according to the present invention has no whitening in its appearance and thus is extremely suitable for optical uses.

The optical film according to the present invention is an optical film obtained by the method for manufacturing an optical film according to the present invention.

The optical film of the present invention has a haze value of, for example, 1 or less, preferably 0.7 or less, and more preferably 0.4 or less, and thus has excellent transparency.

The haze value of the optical film is not particularly limited, and can be measured by, for example, a hazemeter (trade name: HM-150; manufactured by Murakami Color Research Laboratory).

In the optical film of the present invention, the thickness of the coating layer is, for example, 50 to 500 nm, preferably 70 to 100 nm, and more preferably 80 to 90 nm.

In the manufacturing method of the present invention, an additional layer further may be formed on a surface of the coating layer formed on the transparent film. For example, a hard coat layer further may be formed on the coating layer to provide an optical film with a three-layer structure. Alternatively, a hard coat layer exhibiting a relatively high refractive index may be formed on the coating layer and then a coat layer exhibiting a relatively low refractive index may be formed on a surface of the hard coat layer to provide an optical film with a four-layer structure. Other than the above-described coat layers, various types of conventionally known optical layers that will be described later further may be arranged, for example. Note here that the hard coat layer exhibiting a relatively high refractive index means the hard coat layer having a higher refractive index than the coat layer, and similarly, the coat layer exhibiting a relatively low refractive index means the coat layer having a lower refractive index than the hard coat layer. That is, in the present invention, when forming a coat layer on a hard coat layer, it is preferable that the hard coat layer has a higher refractive index than the coat layer.

The optical film of the present invention, configured so that it further includes, on the surface of the coating layer formed on the transparent film, a coat layer exhibiting a relatively low refractive index via a hard coat layer exhibiting a relatively high refractive index, as described above, can be used preferably as an antireflection film. When the optical film is used in an image display apparatus, reflected glare of external light such as sunlight or light from a fluorescent lamp on the image display apparatus can be prevented sufficiently, for example.

The method of forming the hard coat layer is not particularly limited, and conventionally known methods can be used. For example, the hard coat layer can be formed by coating the surface of the coating layer with a coating solution containing a resin or a coating solution in which a resin and ultra-fine particles (with a particle diameter of 100 nm or smaller, for example) are dispersed and then drying the resultant coating. The coating can be hardened by ultraviolet irradiation, if necessary. When forming the hard coat layer exhibiting a relatively high refractive index and the coat layer exhibiting a relatively low refractive index, the refractive index of these layers can be controlled by, for example, setting the content of the ultra-fine particles in the coating solution, the type of the ultra-fine particles, the type of the resin, etc. as appropriate.

The thickness of the hard coat layer exhibiting a relatively high refractive index is, for example, 1 to 30 μm, preferably 1 to 20 μm, and more preferably 1 to 10 μm. On the other hand, the thickness of the coat layer exhibiting a relatively low refractive index is, for example, in the range from 0.05 to 0.5 μm, preferably from 0.1 to 0.3 μm.

Preferably, the hard coat layer exhibiting a relatively high refractive index has a refractive index of 1.50 to 1.80. The resin used for forming the hard coat layer is not particularly limited, but ultraviolet-curing resins are preferable because the treatment for forming the layer can be performed efficiently.

Examples of the ultraviolet-curing resin include ultraviolet-curing resins based on urethane, acrylic substances, polyester, polyalylate, sulfone, amide, imide, polyethersulfone, polyetherimide, polycarbonate, silicone, fluorine, polyolefin, styrene, vinylpyrrolidone, cellulose, acrylonitrile, epoxy, and the like. Also, it is possible to use, for example, a resin layer that is formed by blending an ultraviolet polymerization initiator, a polymerization inhibitor, or the like, such as benzophenone or benzoin ethyl ether, into an oligomer or polymer with a mass-average molecular weight of about 1000 to 5000 and then performing a hardening treatment through ultraviolet irradiation. These resins may be used alone or in the form of a blend of at least two kinds thereof.

Examples of a material of the ultra-fine particles include: inorganic materials such as the metals and metal oxides mentioned above, glass, and silica; and organic materials such as alumina, titania, zirconia, acrylic resins, polyester-based resins, epoxy resins, melanin-based resins, urethane-based resins, polycarbonate-based resins, polystyrene-based resins, silicone-based resins, benzoguanamine, melanin-benzoguanamine condensation products, and benzoguanamine-formaldehyde condensation products. The average particle diameter of the ultra-fine particles is, for example, in the range from 5 to 100 nm.

Other than the above-described ultra-fine particles, conductive inorganic ultra-fine particles formed of, for example, tin oxides, indium oxides, antimony oxides, and the like also can be used for an antistatic purpose. It is also possible to use the ultra-fine particles together with the conductive inorganic ultra-fine particles. The average particle diameter of the conductive inorganic ultra-fine particles is the same as that of the above-described ultra-fine particles, for example. It is to be noted that, the above-described ultra-fine particles and the conductive inorganic ultra-fine particles may have a uniform size or may be a mixture of ultra-fine particles with different sizes.

The hard coat layer exhibiting a relatively high refractive index can also be used as an anti-glare layer by, for example, further being subjected to an anti-glare treatment. This is particularly preferable especially when the optical film of the present invention is an antireflection film, because not only an effect of reducing light reflected by the surface but also an anti-glare effect can be obtained. After being subjected to an anti-glare treatment, the surface of the hard coat layer exhibiting a relatively high refractive index preferably has a centerline average roughness of 0.01 to 0.1 μm. The centerline average roughness of the surface can be measured according to JIS B 0601, for example.

The anti-glare treatment can be carried out by, for example, a surface roughening treatment using sand-blasting, an emboss roll, chemical etching, or the like, a transfer method using a die, or dispersing fine particles in a material for forming a hard coat layer to provide microscopic asperities on a surface of the resultant hard coat layer. When providing microscopic asperities on the surface of the hard coat layer, the hard coat layer preferably is formed using an ultraviolet-curing resin containing fine particles, for example. As the fine particles, the above-described ultra-fine particles, conductive inorganic fine particles, and the like can be used. Other than these, it is possible to use crosslinked or uncrosslinked organic particles of polymers such as polymethyl methacrylate (PMMA), polyurethane, polystyrene, melamine resins, and the like, for example. The average particle diameter of the fine particles is, for example, 0.5 to 5 μm, preferably 1 to 4 μm.

On the other hand, the coat layer exhibiting a relatively low refractive index preferably has a refractive index in the range from 1.35 to 1.45, for example. The resin used for forming such a coat layer is not particularly limited, but can be, for example, an acetate-based resin such as triacetyl cellulose, a polyester-based resin, a polyethersulfone-based resin, a polycarbonate-based resin, a polyamide-based resin, an acrylic resin, or the like. Other than these, it is also possible to use, for example, an ultraviolet-curing acrylic resin, a hybrid material obtained by dispersing inorganic fine particles such as colloidal silica or the like in a resin, or a sol-gel material using a metal alkoxide such as tetraethoxysilane or methyltrimethoxysilane. These materials may contain, for example, a fluorine group-containing component in order to provide a surface antifouling property. Among these, a sol-gel material is preferable because a material with a higher inorganic component content tends to exhibit a higher abrasion resistance.

The optical film according to the present invention also can be used as a protective film of a polarizing plate, for example. This is particularly advantageous when the optical film is an antireflection film as described above, because the optical film protects a polarizer (a polarizing film) and also exhibits an antireflection function.

Next, a polarizing plate according to the present invention includes a polarizing film and a protective film, and the optical film according to the present invention is arranged on at least one surface of the polarizing film. There is no limitation on the configuration, structure, or the like of the polarizing plate according to the present invention as long as the protective film is the optical film according to the present invention, and the polarizing plate may include an additional optical layer. The protective film may be arranged on one or both surfaces of the polarizing film. When arranged on both surfaces of the polarizing film, both of the protective films can be the optical films of the present invention or either one of the protective films can be the optical film of the present invention.

There is no particular limitation on the polarizing film, and it is possible to use, for example, polarizing films that are prepared by a conventionally-known method in which various films are dyed through adsorption of a dichronic substance such as iodine or a dichronic dye and then are crosslinked, stretched, and dried. Among these, films that transmit linearly polarized light when natural light is incident thereon are preferable, and films that are excellent in light transmittance and polarization degree are preferable. Examples of the various films that are allowed to adsorb the dichronic substance include hydrophilic polymer films such as a polyvinyl alcohol (PVA) film, a partially formalized PVA film, a partially saponified film of ethylene-vinyl acetate copolymer, a cellulose film, etc. In addition, for example, polyene alignment films of dehydrated PVA, dehydrochlorinated polyvinyl chloride, etc. also can be used. Among these, a PVA film is preferable. The thickness of the polarizing film usually is in the range from 1 to 80 μm but is not limited thereto.

Examples of the optical layer include various optical layers that have been conventionally known and used in image display apparatuses, such as a reflection plate, a semitransparent reflection plate, a retardation plate (e.g., a wavelength plate, a compensation plate, a viewing angle compensation plate, etc.), and a brightness-enhancement film. These optical layers may be used alone or in combination of at least two kinds thereof. Such an optical layer can be provided as a single layer, or at least two optical layers can be laminated. In the polarizing plate according to the present invention, there is no particular limitation on the method of laminating the respective components such as the optical film of the present invention, the polarizing film, and other optical layers, and conventionally known adhesives and pressure sensitive adhesives can be used.

The optical film and the polarizing plate according to the present invention and the resin sheet can be used for various purposes. Advantageously, the optical film and the polarizing plate also can be used as a liquid crystal cell substrate, a substrate for an image display apparatus such as an EL display, and a substrate for a solar cell, for example. When using the optical film and the polarizing plate as any of various types of substrates as described above, they may be used in the same manner as in the case of using a conventionally used transparent substrate such as a glass substrate or the like, for example.

The optical film and the polarizing plate according to the present invention can be used for various image display apparatuses such as liquid crystal displays, EL displays, PDPs, and FEDs. It is to be noted, however, that there is no limitation on the configuration, structure, or the like of an image display apparatus according to the present invention, as long as it includes at least one of the polarizing plate and the optical film according to the present invention.

In the following, the present invention will be described more specifically by way of examples and comparative examples. It is to be noted, however, that the present invention is by no means limited to the examples below. Measurements of the particle diameter of ultra-fine particles and the refractive index were carried out by the following methods, and the total amount of a thermosetting resin and an inorganic filler (i.e., the solid content) in a coating material was calculated by the following method.

(Method of Measuring Particle Diameter)

The average particle diameter of ultra-fine particles was measured using a laser diffraction/scattering particle size distribution analyzer (trade name: LA-920; manufactured by JASCO Corporation).

(Method of Measuring Refractive Index)

The refractive index was measured using an automatic wavelength scanning ellipsometer (trade name: M-220; manufactured by JASCO Corporation).

(Method of Calculating Solid Content)

The solid content was determined according to JIS K5601-1-2 (1999). Specifically, a coating material was placed on an aluminum pan and dried at 140° C. for 30 minutes. The solid content was calculated based on the thus-obtained residue.

### EXAMPLE 1

A thermosetting resin (tetraalkoxysilane: 100 parts by weight) and an inorganic filler (AOT ultra-fine particles: 900 parts by weight) were dispersed in a mixed solvent (cyclohexanone: 33 wt %, ethanol: 38 wt %, methanol: 8 wt %, MEK: 4 wt %, PGM: 17 wt %), thus preparing a coating material for forming a coating layer. The coating material had a solid content of 1.29 wt %. The particle diameter of the ultra-fine particles was 10 to 60 nm.

A surface of an 80 μm thick unsaponified TAC film was coated with the coating material using a wire bar (trade name: Wire Bar #10 SA-203; manufactured by TESTER SANGYO CO,. LTD.), thus forming a coating on the surface. The coating was air-dried for 30 seconds, after which the coating was further heat-treated at 130° C. for 2 minutes so as to harden the thermosetting resin by heat. Thus, a coating layer having a thickness of 80 to 90 nm was formed on the surface of the unsaponified TAC film.

Subsequently, a hard coat layer was further formed on a surface of the coating layer. First, an ultraviolet-curing resin (an acrylic resin: 20 parts by weight) and ZrO₂ fine particles (80 parts by weight) were dispersed in a mixed solvent MEK: 30 wt %, xylene: 70 wt %), thus preparing a coating material for forming a hard coat layer. The coating material had a solid content of 40 wt %. The particle diameter of the ZrO₂ fine particles was 10 to 100 nm. Then, a surface of the coating layer was coated with the coating material for forming a hard coat layer, thus forming a coating on the surface. The coating was air-dried for 30 seconds so that the thickness of the coating became 2.2 μm. Then, the coating was further dried by heating at 120° C. for 30 minutes and then the ultraviolet-curing resin was hardened by ultraviolet irradiation, thus forming a hard coat layer on the coating layer. In this manner, the laminate of the TAC film, the coating layer, and the hard coat layer was produced as an antireflection optical film.

### EXAMPLE 2

An antireflection optical film was produced in the same manner as in Example 1, except that the coating material for forming a coating layer had a solid content of 1.35 wt % and the mixed solvent contained 30 wt % of cyclohexanone, 39 wt % of ethanol, 9 wt % of methanol, 4 wt % of MEK, and 17 wt % of PGM.

### EXAMPLE 3

An antireflection optical film was produced in the same manner as in Example 1, except that the coating material for forming a coating layer had a solid content of 1.67 wt %.

### EXAMPLE 4

An antireflection optical film was produced in the same manner as in Example 2, except that the coating material for forming a coating layer had a solid content of 1.74 wt %.

### EXAMPLE 5

An antireflection optical film was produced in the same manner as in Example 1, except that the coating material for forming a coating layer had a solid content of 1.45 wt % and the mixed solvent contained 25 wt % of cyclohexanone, 42 wt % of ethanol, 9 wt % of methanol, 5 wt % of MEK, and 19 wt % of PGM.

### EXAMPLE 6

An antireflection optical film was produced in the same manner as in Example 1, except that the coating material for forming a coating layer had a solid content of 1.26 wt % and the mixed solvent contained 35 wt % of cyclohexanone, 37 wt % of ethanol, 8 wt % of methanol, 4 wt % of MEK, and 16 wt % of PGM.

### COMPARATIVE EXAMPLE 1

An antireflection optical film was produced in the same manner as in Example 1, except that the coating material for forming a coating layer had a solid content of 1.03 wt % and the mixed solvent contained 47 wt % of cyclohexanone, 30 wt % of ethanol, 7 wt % of methanol, 3 wt % of MEK, and 13 wt % of PGM.

### COMPARATIVE EXAMPLE 2

An antireflection optical film was produced in the same manner as in Example 1, except that the coating material for forming a coating layer had a solid content of 1.11 wt % and the mixed solvent contained 43 wt % of cyclohexanone, 32 wt % of ethanol, 7 wt % of methanol, 4 wt % of MEK, and 14 wt % of PGM.

### COMPARATIVE EXAMPLE 3

An antireflection optical film was produced in the same manner as in Example 1, except that the coating material for forming a coating layer had a solid content of 1.19 wt % and the mixed solvent contained 38 wt % of cyclohexanone, 35 wt % of ethanol, 8 wt % of methanol, 4 wt % of MEK, and 15 wt % of PGM.

### COMPARATIVE EXAMPLE 4

An antireflection optical film was produced in the same manner as in Example 1, except that the coating material for forming a coating layer had a solid content of 1.55 wt % and the mixed solvent contained 20 wt % of cyclohexanone, 45 wt % of ethanol, 10 wt % of methanol, 5 wt % of MEK, and 20 wt % of PGM.

### COMPARATIVE EXAMPLE 5

An antireflection optical film was produced in the same manner as in Comparative Example 1, except that the coating material for forming a coating layer had a solid content of 1.33 wt %.

### COMPARATIVE EXAMPLE 6

An antireflection optical film was produced in the same manner as in Comparative Example 2, except that the coating material for forming a coating layer had a solid content of 1.43 wt %.

### COMPARATIVE EXAMPLE 7

An antireflection optical film was produced in the same manner as in Comparative Example 3, except that the coating material for forming a coating layer had a solid content of 1.54 wt %.

### COMPARATIVE EXAMPLE 8

An antireflection optical film was produced in the same manner as in Comparative Example 4, except that the coating material for forming a coating layer had a solid content of 2 wt %.

### COMPARATIVE EXAMPLE 9

An antireflection optical film was produced in the same manner as in Example 1, except that the coating material for forming a coating layer had a solid content of 1.19 wt % and the mixed solvent contained 15 wt % of cyclohexanone, 35 wt % of ethanol, 8 wt % of methanol, 4 wt % of MEK, 15 wt % of PGM, and 23 wt % of n-butyl acetate.

### COMPARATIVE EXAMPLE 10

An antireflection optical film was produced in the same manner as in Comparative Example 9, except that the mixed solvent contained ethylcellosolve instead of n-butyl acetate.

### COMPARATIVE EXAMPLE 11

An antireflection optical film was produced in the same manner as in Comparative Example 9, except that the mixed solvent contained MIBK instead of n-butyl acetate.

### COMPARATIVE EXAMPLE 12

An antireflection optical film was produced in the same manner as in Comparative Example 9, except that the mixed solvent contained cyclopentanone instead of n-butyl acetate.

### COMPARATIVE EXAMPLE 13

An antireflection optical film was produced in the same manner as in Example 1, except that the coating material for forming a coating layer had a solid content of 1.47 wt % and the mixed solvent contained 24 wt % of cyclohexanone, 43 wt % of ethanol, 9 wt % of methanol, 5 wt % of MEK, and 19 wt % of PGM.

### COMPARATIVE EXAMPLE 14

An antireflection optical film was produced in the same manner as in Example 1, except that the coating material for forming a coating layer had a solid content of 1.24 wt % and the mixed solvent contained 36 wt % of cyclohexanone, 36 wt % of ethanol, 8 wt % of methanol, 4 wt % of MEK, and 16 wt % of PGM.

With regard to each of the optical films obtained in Examples 1 to 6 and Comparative Examples 1 to 14, the adhesion between the TAC film and the coating layer and the whitening of the TAC film due to the formation of the coating layer formed were evaluated by the following methods. The results are shown in Table 1 below.

(Adhesion Test)

To examine the adhesion between the TAC film and the coating layer in each of the optical films, a cross-cut peeling test was conducted according to JIS K 5400. A cellophane tape (trade name: N.29; width: 24 mm) manufactured by Nitto Denko Corporation was used as a peeling tape. The test result was shown as “the number of peeled-off grids/100”, which was evaluated according to the following evaluation criteria. Note here that, in this adhesion test, evaluation was made with respect to the untreated optical film, the optical film that had been subjected to a moistening treatment at 40° C.×92% RH for predetermined times (2 hours, 12 hours, 96 hours), and the optical film that had been subjected to a moistening treatment at 80° C.×90% RH for predetermined times (2 hours, 12 hours, 96 hours).

[Table 1]

(Evaluation Criteria)

| The number of peeled-off grids/100 | Evaluation |
|---|---|
| 0/100 | ∘ |
| 1/100 to 50/100 | Δ |
| 51/100 to 100/100 | x |

(Method of Evaluating Whitening)

The haze value of each of the optical films was measured using a hazemeter (trade name: HM-150; manufactured by Murakami Color Research Laboratory) according to JIS K 7150. The whitening of the optical film was evaluated according to the following criteria: the haze value of not less than 0 and not more than 0.4 was evaluated as ∘; the haze value of more than 0.4 and less than 0.8 was evaluated as Δ, and the haze value of 0.8 or more was evaluated as ×. Note here that Δ and × indicate that the optical film has a problem of whitening.

TABLE 2

| | | | | Ex. 1 | Ex. 2 | Ex. 3 | Ex. 4 | Ex. 5 | Ex. 6 |
|---|---|---|---|---|---|---|---|---|---|
| Concentration of thermosetting resin (wt %) | | | | 10 | 10 | 10 | 10 | 10 | 10 |
| Concentration of cyclohexanone (wt %) | | | | 33 | 30 | 33 | 30 | 25 | 35 |
| Solid content (wt %) | | | | 1.29 | 1.35 | 1.67 | 1.74 | 1.45 | 1.26 |
| Evaluation of | Untreated | | | ∘ | ∘ | ∘ | ∘ | ∘ | ∘ |
| adhesion | 40° C. | 92% RH | 2 hr | ∘ | ∘ | ∘ | ∘ | ∘ | ∘ |
| | 80° C. | 92% RH | 2 hr | ∘ | ∘ | ∘ | ∘ | ∘ | ∘ |
| | 40° C. | 92% RH | 12 hr | — | — | ∘ | — | — | — |
| | 80° C. | 92% RH | 12 hr | — | — | Δ | — | — | — |
| | 40° C. | 92% RH | 96 hr | ∘ | — | — | — | Δ | ∘ |
| | 80° C. | 92% RH | 96 hr | ∘ | — | — | — | — | ∘ |

| | | | | | | | |
|---|---|---|---|---|---|---|---|
| Whitening | Haze value | 0.3 | 0.1 | 0.3 | 0.1 | 0.1 | 0.4 |
| | Evaluation | ∘ | ∘ | ∘ | ∘ | ∘ | ∘ |

TABLE 3

| | | | | Comp. | Comp. | Comp. | Comp. | Comp. | Comp. | Comp. |
|---|---|---|---|---|---|---|---|---|---|---|
| | | | | Ex. 1 | Ex. 2 | Ex. 3 | Ex. 4 | Ex. 5 | Ex. 6 | Ex. 7 |
| Concentration of thermosetting resin (wt %) | | | | 10 | 10 | 10 | 10 | 10 | 10 | 10 |
| Concentration of cyclohexanone (wt %) | | | | 47 | 43 | 38 | 20 | 47 | 43 | 38 |
| Solid content (wt %) | | | | 1.03 | 1.11 | 1.19 | 1.55 | 1.33 | 1.43 | 1.54 |
| Evaluation of | Untreated | | | ∘ | ∘ | ∘ | ∘ | ∘ | ∘ | ∘ |
| adhesion | 40° C. | 92% RH | 2 hr | ∘ | ∘ | ∘ | ∘ | ∘ | ∘ | ∘ |
| | 80° C. | 92% RH | 2 hr | ∘ | ∘ | ∘ | x | ∘ | ∘ | ∘ |
| | 40° C. | 92% RH | 12 hr | — | — | — | — | — | ∘ | ∘ |
| | 80° C. | 92% RH | 12 hr | — | — | — | — | — | Δ | Δ |
| | 40° C. | 92% RH | 96 hr | ∘ | ∘ | ∘ | x | ∘ | — | — |
| | 80° C. | 92% RH | 96 hr | ∘ | ∘ | ∘ | x | ∘ | — | — |

| | | | | | | | | |
|---|---|---|---|---|---|---|---|---|
| Whitening | Haze value | 1.5 | 0.7 | 0.6 | 0.1 | 1.4 | 0.7 | 0.6 |
| | Evaluation | x | Δ | Δ | ∘ | x | Δ | Δ |

TABLE 4

| | | | | Comp. | Comp. | Comp. | Comp. | Comp. | Comp. | Comp. |
|---|---|---|---|---|---|---|---|---|---|---|
| | | | | Ex. 8 | Ex. 9 | Ex. 10 | Ex. 11 | Ex. 12 | Ex. 13 | Ex. 14 |
| Concentration of thermosetting resin (wt %) | | | | 10 | 10 | 10 | 10 | 10 | 10 | 10 |
| Concentration of cyclohexanone (wt %) | | | | 20 | 15 | 15 | 15 | 15 | 24 | 36 |
| Solid content (wt %) | | | | 2.00 | 1.29 | 1.29 | 1.29 | 1.29 | 1.47 | 1.24 |
| Evaluation of | Untreated | | | x | ∘ | ∘ | ∘ | ∘ | ∘ | ∘ |
| adhesion | 40° C. | 92% RH | 2 hr | Δ | ∘ | x | x | ∘ | ∘ | ∘ |
| | 80° C. | 92% RH | 2 hr | x | x | x | x | x | Δ | ∘ |
| | 40° C. | 92% RH | 12 hr | x | — | — | — | — | — | — |
| | 80° C. | 92% RH | 12 hr | x | — | — | — | — | — | — |
| | 40° C. | 92% RH | 96 hr | — | — | — | — | — | x | ∘ |
| | 80° C. | 92% RH | 96 hr | — | — | — | — | — | — | ∘ |

| | | | | | | | | |
|---|---|---|---|---|---|---|---|---|
| Whitening | Haze value | 0.1 | 3.2 | 0.2 | 0.2 | 0.7 | 0.1 | 0.5 |
| | Evaluation | ∘ | x | ∘ | ∘ | Δ | ∘ | Δ |

As shown in Tables 2 to 4, in the comparative examples where the content of cyclohexanone in the mixed solvent is less than 25 wt % or more than 35 wt %, the evaluation of at least one of the adhesion and the whitening was not good. In contrast, the optical films according to the examples achieved excellent adhesion and had excellent appearance with no whitening (evaluation: ∘).

### INDUSTRIAL APPLICABILITY

As specifically described above, by using the coating material according to the present invention, a coating layer with excellent adhesion can be formed on a surface of a transparent film. Thus, the optical film according to the present invention including a transparent film and a coating layer formed on the transparent film is useful as an antireflection film in various image display apparatuses even in an environment where the temperature and humidity are liable to change, for example.

1. A coating material for forming a coating layer on a surface of a transparent film, the coating material comprising:
a thermosetting resin;
an inorganic filler; and
a mixed solvent that contains at least two solvents,
wherein a content of the thermosetting resin is in a range from 5 to 20 wt % with respect to a total amount of the thermosetting resin and the inorganic filler, and
the mixed solvent contains cyclohexanone so that a content of the cyclohexanone is in a range from 25 to 35 wt % with respect to the entire mixed solvent.

2. The coating material according to claim 1, wherein the thermosetting resin comprises a siloxane-based resin.

3. The coating material according to claim 1, wherein the thermosetting resin comprises alkoxysilane.

4. The coating material according to claim 1, wherein a total content of the thermosetting resin and the inorganic filler is 1 to 2 wt % with respect to a total amount of the thermosetting resin, the inorganic filler, and the mixed solvent.

5. The coating material according to claim 1, wherein the inorganic filler comprises at least one of metal fine particles and metal oxide fine particles.

6. The coating material according to claim 1, wherein the transparent film is a protective film of a polarizing plate.

7. The coating material according to claim 1, wherein the transparent film is a triacetylcellulose (TAC) film.

8. The coating material according to claim 7, wherein the triacetylcellulose (TAC) film is a triacetylcellulose (TAC) film that is not saponified.

9. A method for manufacturing an optical film that comprises a transparent film and a coating layer formed on a surface of the transparent film, the method comprising:
coating the surface of the transparent film with the coating material according to claim 1 to form a coating; and
heat-treating the coating to obtain the coating layer.

10. The method according to claim 9, wherein the coating layer has a thickness in a range from 50 to 500 nm.

11. The method according to claim 9, wherein the transparent film is a triacetylcellulose (TAC) film.

12. The method according to claim 11, wherein the triacetylcellulose (TAC) film is a triacetylcellulose (TAC) film that is not saponified.

13. The method according to claim 9, further comprising forming a hard coat layer on a surface of the coating layer.

14. The method according to claim 13, further comprising forming a coat layer having a lower refractive index than the hard coat layer on a surface of the hard coat layer.

15. An optical film comprising:
a transparent film; and
a coating layer formed on a surface of the transparent film,
wherein the optical film is obtained by the method according to claim 9.

16. The optical film according to claim 15, wherein a hard coat layer is formed on a surface of the coating layer, and a coat layer having a lower refractive index than the hard coat layer is formed on a surface of the hard coat layer.

17. An antireflection film comprising the optical film according to claim 16.

18. A protective film for protecting a polarizing film comprising the optical film according to claim 15.

19. A polarizing plate comprising a polarizing film and a protective film arranged on at least one surface of the polarizing film,
wherein the protective film is the optical film according to claim 15.

20. An image display apparatus comprising the optical film according to claim 15.

21. An image display apparatus comprising the optical film according to claim 16.

22. An image display apparatus comprising the optical film according to claim 17.

23. An image display apparatus comprising the optical film according to claim 18.

24. An image display apparatus comprising the polarizing plate according to claim 19.
